(19) United States
(12) Patent Application Publication
(10) Pub. No.: US 2001/0047297 A1
(43) Pub. Date: Nov. 29, 2001

(54) Advertisement brokering with remote ad generation system and method in a distributed computer network

(76) Inventor: Albert Wen, San Francisco, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/784,702

(22) Filed: Feb. 14, 2001

Related U.S. Application Data
(60) Provisional application No. 60/182,763, filed on Feb. 16, 2000.

(51) Int. Cl. G06F 17/60

(52) U.S. Cl. 705/14; 705/1

(57) ABSTRACT

A method of remotely creating an advertisement in a distributed communications network is described, wherein the created ad is used for presentation to a client-user with a publisher web page and is created by a client-advertiser that communicates with an ad generation server. In one embodiment, an advertiser is provided with selections in which the advertiser remotely creates an ad, where each selection is associated with an ad characteristic. In another embodiment, the remotely generated ad is used with an ad broker system for presenting the ad to a user along with a publisher web page.

### CROSS-REFERENCES TO RELATED APPLICATIONS

The present invention claims priority from co-pending U.S. Provisional Patent Application Ser. No. 60/182,763 filed on Feb. 16, 2000, the disclosure of which is incorporated herein in its entirety for all purposes.

### BACKGROUND OF THE INVENTION

The present invention relates to the field of electronic advertising over a communications network. More specifically, one embodiment of the invention provides a system and a method of automatically brokers advertisement space and advertisements for presentation to clients distributed in an advertising system, where such an ad is selected and presented by an ad broker system.

Internet usage by the general public continues to increase. More and more people are accessing the Internet to retrieve information of interest from all of the immense amount of available information. Along with the exponential increase in the number of Internet users, on-line adverting has correspondingly experienced similar growth since advertisements have been included with web pages.

Internet advertising, however, has been generally available only to those companies able to secure the resources either to solicit advertising space on web sites for ad placements or to promote a web site having space available for advertising. Large publishers of web pages (i.e., web site having a large number of web pages), such as business Internet Service Providers (ISPs) offer Internet service and web portals offering a broad array of resources and services, such as e-mail, forums, search engines and on-line shopping malls. Such larger publishers generate a lot of web traffic than other web sites. For example, the top 50 web sites grab approximately 85-90% of advertising revenue.

As many more small to medium businesses gain an Internet presence, the opportunities to generate ad revenue or to promote goods and services increase. However, there are significant barriers that small to medium business must overcome to survive as either an Internet ad publisher or advertiser.

Today, small to medium businesses that wish to buy advertising space on the Internet generally lack technical resources for generating Internet advertisements, such as ad banners or rich-media ads. Furthermore, such businesses do not have the in-house resources (i.e., overhead) to secure advertising space that is commensurate to their advertising budgets. Lastly, advertising space is generally cost prohibitive to the limited budgets of small businesses. For example, large publishers typically require a minimum of one million impressions (views of ads), which effectively sets a minimum budget expenditure at $30,000. This minimum outlay creates a financial barrier for many small and medium size companies struggling to break into the Web advertising market.

Similar barriers exist for small and medium businesses that wish to sell advertising space on the Internet. Such businesses generally lack the resources, such as a sales staff to secure revenue from advertisers, or a technical staff, to integrate Internet ads with their publisher web page. Another barrier to selling Internet ad space is a requirement to enroll in a large ad network. To participate in an ad network, such as DoubleClick, CMGI, and 24/7 Media, small businesses would have to provide at least 1,000,000 page views per month to reach the cost per ad that is within their budget. With low web traffic, it is not possible for small and medium businesses to obtain this amount of Internet traffic to qualify as a publisher of ads provided by the ad networks. Hence, as the market stands today, a large ad network will sell advertising only if the company can deliver a massive amount of traffic or inventory; otherwise, they are not interested.

According to the Forrester Research, Internet advertising revenues are expected to quadruple from 5 billion dollars in 2000 to 22 billion dollars in 2004. More than 55% revenue is expected to the dominant form of advertising includes banner ads, which account for 55% of ad revenues. Today, both small and medium businesses are unable to profitably engage in Internet advertising.

There is a need in the field of internet advertising to provide advertising services to those small and medium businesses which desire either to advertise on the Internet or to provide ad space on their web page that do not possess the resources to do so effectively. More specifically, there is a need for an ad brokering system which allows advertisers and publishers to exchange ad space for payment without significant intervention. Furthermore, the ad broker system provides an advertiser the means to remote generate Internet ads if that advertiser lacks the technical resources to otherwise create the Internet ad itself.

### SUMMARY OF THE INVENTION

The present invention provides a system and a method to small and medium businesses that wish to advertise on the Internet or to provide ad space on their web page, but otherwise that do not possess the resources to effectively do so. More specifically, the present invention provides a method and an ad brokering system which allows advertisers and publishers to exchange ad space for payment wherein an advertiser is provided the resources to remotely generate Internet ads that it otherwise could not without technical resources. Ad brokering may be based upon, for example, elected ad categories and the ability for advertisers to meet the publisher's asking price, where such an ad brokered according to the present invention may be remotely generated.

In one embodiment, a method of creating an advertisement in a distributed communications network is described. The created ad is used for presentation to a client-user with a publisher web page and is created by a client-advertiser that communicates with an ad generation server. The method includes providing an client-advertiser with a plurality of selections where each selection is associated with an ad characteristic. An ad characteristic, for example, defines a portion of the advertisement to be generated. Next, the method includes accepting at least one selection to generate the advertisement. Last, the ad is remotely created in the ad generation server when a final portion of the advertisement has been accepted from the client-advertiser. The final portion is associated with a final selection that is made by the advertiser. The remotely created ad is then available for presentation to the user along with the publisher web page.

In another embodiment, an automated ad broker system is disclosed where the system selects a brokered advertisement from a number of advertisements and then presents the brokered advertisement over a communication network to a user. The system includes an account server coupled to the communication network to receive ad presentation data from both publishers and advertisers, and also includes an ad serving engine coupled to the account server to receive the ad presentation data. The ad serving engine is further coupled to the communication network to provide a selected ad to the user. The ad broker system is thus configured to present brokered advertisements where such an advertisement may be remotely generated.

The following detailed description and drawings provide a better understanding of the nature and advantages of the ad broker system according to the present invention.

### BRIEF DESCRIPTION OF THE DRAWINGS

FIG. 1 is a simplified network diagram depicting a specific embodiment of the present invention;

FIG. 2 is a basic computer system for executing the software and program instructions of the present invention;

FIG. 3 is a diagram of subsystems in the computer system of FIG. 2;

FIG. 4 is a more detailed block diagram illustrating an exemplary ad brokering system including an ad generation server for remotely generating advertisements;

FIG. 5 depicts data structures of exemplary repositories according to the present invention;

FIG. 6 shows a flow chart of a specific embodiment of a method of ad brokering;

FIG. 7 shows an exemplary screen display including ad generation selections according to the present invention, wherein the ad is an ad banner;

FIG. 8 shows an exemplary screen display including ad generation selections according to the present invention of ad brokering, wherein the ad is a home-ad page;

FIG. 9 shows a simplified flow chart of a specific embodiment of a method of generating an ad in an ad brokering arrangement;

FIG. 10 shows a screen display of an exemplary electronic form for use according to the present invention; and

FIG. 11 illustrates a screen display for showing to an advertiser exemplary ad presentation inputs and transactional inputs.

### DESCRIPTION OF THE SPECIFIC EMBODIMENTS

The following detailed description of specific embodiments, including preferred embodiments, reference the accompanying drawings that form part of this disclosure. The drawings illustrate examples of the embodiments and how to practice the invention. Without departing from the scope of the present invention, other embodiments may be used in place of those shown and described, and such substitutions should be apparent to one of ordinary skill in the art upon reading this disclosure.

The present invention relates to a system and a method for selecting an advertisement, wherein the advertisement is generated remotely, where in another embodiment, also is selected by an ad broker system. An ad broker system provides a network-based advertising system that automatically and dynamically targets and delivers ads to web users based on pre-selected target audience criteria. In addition, the ad broker system provides web publishers with ad space inventory management capabilities. That is, the system matches and delivers functions a variety of ads based on a variety of publisher-defined criteria including target audiences, audience interests and demographic information. The ad broker system also manages transactional data such as the number, rate of impressions (i.e., rate at which ads are downloaded to a requesting client), the click-through rate (i.e., percentage of ads views that resulted in an ad click), distribution of ad placements throughout the system, and other metrics used by the internet advertising community to determine the success of their ad campaigns.

The ad broker system enables web publishers and advertisers to control the targeting, delivery, measurement and analysis of their own online marketing campaigns, such as reducing the number of “run of network” ads. Run of network ads are typically presented “out-of-context” in contrast to the content and subject matter web publisher's page. Such ads are generally not as effective as targeted ads for securing customer sales. Ads provided by the ad broker system no longer require the practice of using statistics to determine the demographics of web publisher pages. The ad broker creates an online community of Web-publishers and advertisers who need not rely on such statistically determined demographics to target their ads. With an automated ad serving solution provided herein, not only will nation-wide or international advertisers and publishers be served, but so too will be local advertisers and publishers. Local advertisers, who otherwise would not have the resources to secure internet advertising, are provided with a system and a process for engaging in ad brokering and automated Internet ad creation capabilities which requires only the technical skills to navigate web pages.

The present invention is described wherein with reference to a particular type of advertisement, however, it should be understood that the present invention and the embodiments described herein are usable with many other types of advertisements. The advertisements described in at least one of the examples herein are Internet ad banners, wherein such ad banners are generally in GIF (graphics interchange format). GIF is a bit-mapped graphics file format used by the World Wide Web, and may comprise either a static or animated GIF Internet advertisement. Other types of advertisements, such as audio streaming or “rich-media” are also in within the scope of each embodiment of the present invention. Rich media ads comprise either graphics or sound, or both, and provides user interaction and special effects. A rich-media ads as described herein may employ applets, CGI, or a combination thereof. Furthermore, interstitial advertisements are also within the scope of the present invention. Interstitial ads are advertisements that appear in a separate browser window with the publisher web page. “Advertisement” as described herein includes an ad banner associated with a GIF file in the ad database, where the digital representation of the ad is actually stored in the database. Advertisements, however, may also be associated with an ad ID that, as a pointer, points to the actual ad in the database. A “brokered” ad as described herein is an ad which at least has matching advertiser and publisher ad subcategories, but also may have an associated bid price at least equal to a publisher's ask price. Bid and ask prices will be described below. Lastly, an advertisement can be a uniform resource locator address of an external ad repository (not shown) which is accessed to present the ad upon request.

An ad broker system according to one embodiment of the present invention includes an account server coupled to an ad server, where both are in turn configured to communicate over a network, such as the Internet, with one or web users (e.g., HTTP client), one or more advertisers, and/ or one or more web publishers. Over the communication network, the account server receives data representing publisher information and advertiser information. Such information is used by the system to target ads to certain audiences, to exchange monies between the publisher, advertisers, and the ad broker administrator, to generate advertisements and to perform other functions as described herein as well those functions understood by those skilled artisans in the Internet advertising field. An exemplary transactional database is coupled to the account server to store at least one type of the above-mentioned information.

The ad server operates to “push” or provide an Internet ad (i.e., advertising impression) to a requesting publisher web site for presentation to a user. The ad server is coupled to a publisher database and an ad database, each database respectively storing publisher data and advertiser data. In one embodiment of the ad server, the publisher data and advertiser data are provided to the databases by way of the ad server. In another embodiment, the account server provides the data directly to the databases.

Publisher data includes transactional data and ad presentation data specific to the publisher, and includes the kinds of data necessary to monitor transactions as well the data needed to broker publisher web page space. Publisher data includes, for example, a publisher ID to identify the publisher and a corresponding ad web space. It also includes publisher ad characteristics related to the content of the subject matter for determining which category of ad types are most suitable (i.e., “in context”) as well as “blocked” ad types. By blocking ad types at the election of the publisher, particular ad categories and subcategories are denied presentation (e.g., inappropriate subject matter) on the publisher's web page. In a specific embodiment, publisher data also includes an “ask price” which is the minimum price a publisher will accept for selling ad space for a particular ad.

Advertiser data includes transactional data and ad presentation data specific to the advertiser, such as a location in which to access an ad for presentation, whether directly or indirectly by using a URL (Universal Resource Locator) to point to an ad residing external to the ad server. Also included in the advertiser data are advertiser ad presentation characteristics, such as a list of ad categories and subcategories associated with an advertisement. In a specific embodiment, advertiser data also includes an “bid price” which is the maximum price an advertiser will accept for buying ad space for a particular ad.

The ad server also brokers an advertisement based in part, upon the content of the publisher's web page which is related to its target audience as well as the category or subcategory under which the ad falls. The ad server determines which one of the plurality of ads is most appropriate to present to the user. For example, the ad server, under the control proprietary software, operates to select the most appropriate ad. “Appropriateness” and “suitability” are determined according to criteria set by, for example, an ad broker administrator. Determining the most appropriate ad may include the following criteria: the maximum revenue generated, the number of impressions a particular advertiser requires during a certain time period, the degree of match between ad and ad categories elected by the publisher, the highest importance weighting associated with a particular ad, etc. . In a specific embodiment, the ad server operates according to the selection criteria and uses the transactional data from the transactional database.

Thereafter, as the user navigates from the web page serving the first advertisement from the ad broker to another web page affiliated with the ad broker, by accessing the next affiliated web page, a request for an ad is delivered to the ad server, which in turn accesses previously stored ads and determines (i.e., brokers) which of the ads within the ad database will be presented to the user. “Web pages” herein refers to a single hypertext document which forms part of a web site, where “web site” refers to a collection of one or more web pages which are controlled (i.e., modifiable) by a single entity or group of entities working in concert to present a site on a particular publisher web page.

FIG. 1 shows an example of a client-server system 10 in which an Internet advertisement is brokered between web page publishers and advertisers for presentation to a user. System 10 is shown comprising an HTTP client 12 (i.e., “client-user”), an advertiser 14 (i.e., “client-advertiser”) and a publisher 16 (i.e., “client-publisher”) coupled to an ad broker system 20 via Internet 18. In a specific example, HTTP client 12 is a browser, but other HTTP clients, such as search back-end processors, could be used instead of a browser. The advertiser 14 and publisher 16 are illustrated as HTTP servers, but could be any computing device and may communicates using an entirely different protocol, so long as the different protocol is understood by HTTP client 12 and the ad broker system or their substitutes.

It should be understood that system 10 could be implemented with Internet 18 replaced with an alternate communications channel between HTTP client 12, HTTP advertiser 14 and a HTTP publisher 16 and an ad broker system 20. Exemplary ad broker system 20 is configured to reliably pass data using the TCP/IP (Transport Control Protocol/Internet Protocol) via the Internet and other and computers network systems from a source node (e.g., client) to a destination node (e.g., publisher or advertiser server). A variety of higher level protocols is used on top of TCP/IP to transport objects of digital data, the particular protocol depending on the nature of the objects. For example, hypertext documents and their associated effects are transported using the Hypertext Transport Protocol (HTTP).

Although it should be understood that ad broker system 20 may be an HTTP server, it can handle requests using an entirely different protocol, so long as the different protocol is understood by HTTP client 12 or its substitute. For brevity, only one HTTP client, one request and one response is shown, but it should be understood that in practice many clients will be receiving ads from ad broker system 20 substantially simultaneously, each with one or more page requests. Additionally, although only one advertiser 14 and one publisher 16 are shown with respective single requests and responses, it should also be understood that in practice many advertisers and many publishers will be brokering ads with the ad broker system 20 substantially simultaneously, each with one or more page and ad requests. In fact, if warranted, the tasks of the ad broker system 20 might be embodied in a single machine or server, rather than spread over multiple machines as shown in FIG. 1. If the tasks are spread over multiple machines, the preferred arrangement is to have the multiple machines presented to the clients, advertisers and publishers as a single logical machine, to simplify client access.

In an exemplary embodiment of multiple machines, the ad broker system 20 includes ad server 32, account server 30, and ad generation server 34, where each server is cross-coupled to communicate (bi-directionally) directly to the other servers, or are coupled by a LAN (Local Area Network) or the like. Such servers may be interconnected by any communication means and in any network topology. For example, the servers can be connected by hardwire, radio frequency transmissions, infrared transmissions, etc. They can be connected in a star, ring, daisy chain, etc., schemes. In addition, any communication protocol such as Ethernet, IEEE 1394 or TCP/IP can be employed.

Account server 30 is coupled to a transactional database 42 for storing and accessing ad broker account information, where such information includes data received from the advertisers and publishers. Ad server 32 is coupled to both a publisher database 44 and an ad database 46 for storing and accessing publisher ad presentation data and advertiser ad presentation data, respectively. Account server 30 is configured to receive publisher ad presentation data from the publisher database 44, the publisher ad presentation data including a publisher ID to identify the publisher and a list of ad subcategories most suitable for presentation on the attending publisher web page to client 12. The ad server is also coupled to an ad repository, such as the ad database 46 for storing and accessing advertiser ad presentation data, where such data represents, for example a URL associated with the ad (e.g., an advertiser database external to the ad broker system 20). Each of the machines in the ad broker system 20 are further coupled to the Internet 18 for communicating information to the client 12, the advertiser 14, and the publisher 16. Account server 30 is configured to exchange information between advertiser 14 and publisher 16 to establish or to maintain ad brokerage accounts. For example, publishers provide financial account numbers for receiving a credited amount when its web page presents an advertiser's ad to a client. Such account numbers, both applicable to publishers and advertisers, include credit card numbers, expiration dates, name of account holder, and check or financial institution routing numbers. Ad server 32 is configured to exchange information with client 12, the advertiser 14, and the publisher 16, such as receiving an ad request from publisher 16 to select an appropriate ad to be published on a web page served to the client 12.

In another embodiment, an ad generation server 34 is configured to receive, for example, information necessary for an advertiser 14 to generate an ad remotely on ad generation server 34. “Ad generation” as described herein is the creation of an advertisement from ad characteristics (i.e., ad generation characteristics) provided by the advertiser, whereby the ad is remotely created, formed or produced. The ad generation server 34 is coupled to store the generated ad in ad database 46 so as to be available for presentation to a user, if selected by ad server 32. One embodiment of the ad generation server 34 generates an ad banner from data provided by the advertiser 14. Such an ad banner is filed as a GIF file in the ad database 46, or as an URL address of an external ad repository (not shown) for accessing the ad banner upon request. Another embodiment of the ad generation server 34 generates an home page from data provided by the advertiser 14. A home page is web page remotely generated by an advertiser 14 and is stored in a home page hosting database (not shown). A generated home page enables smaller business without technical expertise to obtain an Internet presence.

In a specific embodiment, a web server 453 is interposed and coupled between the client 12, the advertiser 14, and the publisher 16 (i.e., local machines) and ad server 32, account server 30, and ad generation server 34. The web server is configured to exchange information between the local machines, and to operate as a single gateway to the Internet 18, providing among other things, a data manager function. The web server machine is similar in structure and functionality to the above-mentioned machines and one skilled in the art of networked computing devices should understand how to include such a web server without undue effort or experimentation.

In yet another embodiment, the multiple machines may be cross-coupled to each other and individually coupled to the internet, or may be configured to communicate with each other and the Internet by way of a either a Local or Wide Area Network (LAN or WAN). Such computer networks permit networked computing devices such as the ad server 232 to communicate with, for example, the account server (not shown in FIG. 2). A skilled artisan should recognize the most appropriate protocol for networked elements to exchange data, given its exemplary architecture (i.e., peer-to-peer or client-server), as well how best to physically to implement the interconnections between such elements (i.e., whether the communications media is a twisted-pair wire, coaxial cables, fiber optic cables, or radio waves).

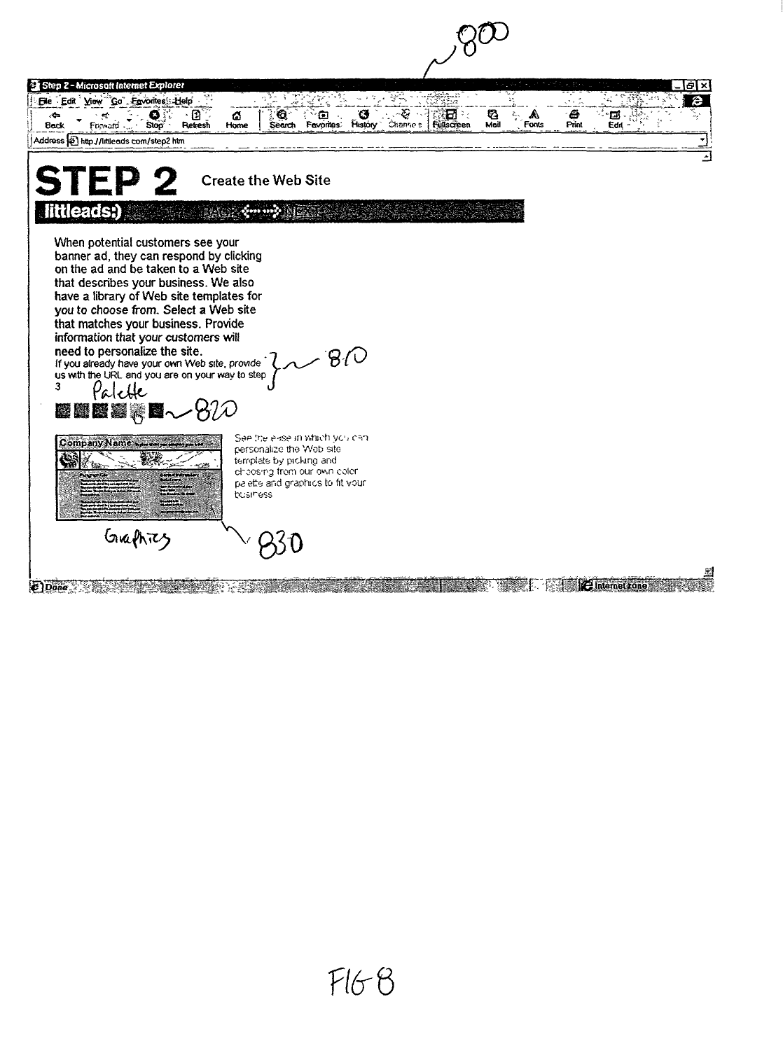

In operation, a potential advertiser or publisher registers with the ad broker system 20 by, for example, populating an exemplary electronic form, as shown in FIG. 7, with text and other data necessary for the potential advertiser or publisher to establish an ad brokering account. Account server 30 parses the data received in the form and uses data to generate publisher and advertiser accounts as well as ads to be stored in transactional database 42. The account server 30 generally parses data into two types: transactional data and ad presentation data. Transactional data includes information (i.e., transactional characteristics) necessary to monitor ad presentations of brokered ads and to report data generated by the brokering of ads. Transactional characteristics, for example, identify the publishers and advertisers, account information for crediting (if publisher) and debiting (if advertiser), and other kinds of information necessary to transact ad brokering, such as an indication that a particular ad has been served (for billing the advertiser) and an indication that a particular ad space presented an ad (for paying the publisher).

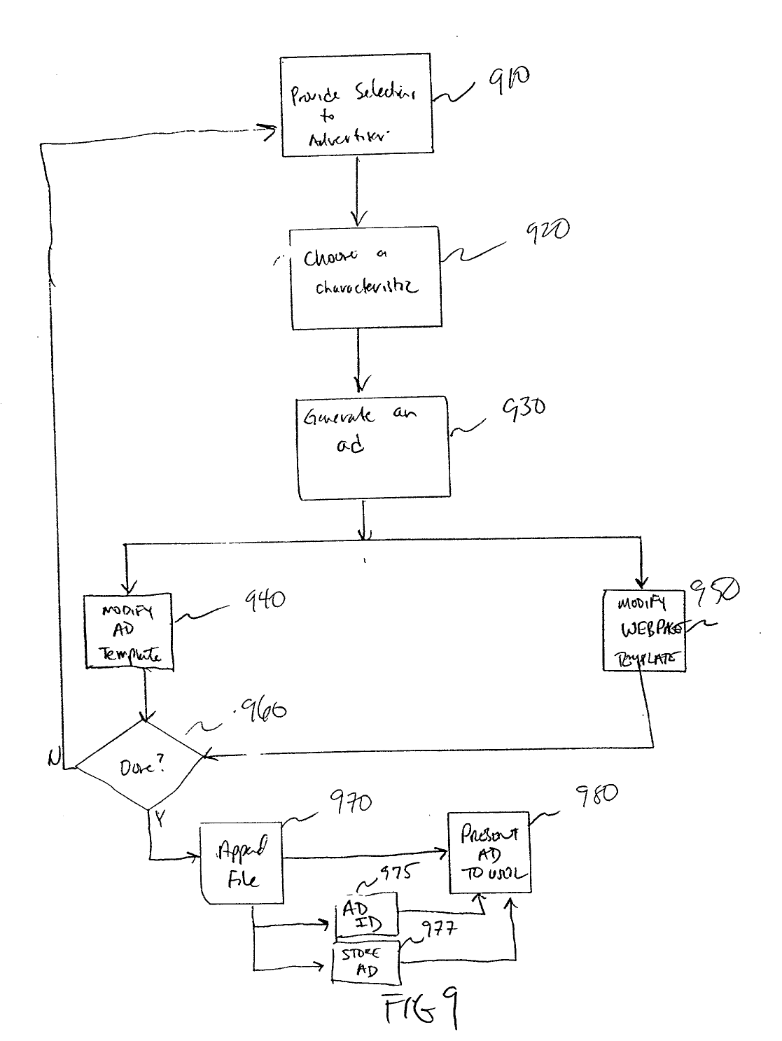

Ad presentation data includes that information (i.e., ad presentation characteristics) required to select ads for presentation, and includes the ads themselves, the ad space URL, available ad subcategories, etc. Such ad presentation data is provided by both publishers and advertisers so as to match and select the most appropriate ads between specific publishers and advertisers. FIG. 8 depicts exemplary transactional and ad presentation data presented to the advertiser in which to elect. Publishers are presented with similar ad presentation selections to accept. In one embodiment, account server 30 directly provides publisher ad presentation characteristics and advertiser ad presentation characteristics to the publisher database 44 and ad database 46, respectively. In a specific embodiment, the advertiser ad presentation characteristics include data representing the advertisement itself. HTML, DHTML, XML or a substitute programming language are suitable for creating a form, or implementing other aspects of the present invention.

When HTTP client 12 requests a web page from a publisher registered with the ad broker system 20, the publisher 16 substantially in parallel initiates both an ad request to ad server 32 and a publisher web page request from its web host machine or server (not shown). As the requested web page is being fetched, ad server 32 receives the ad request over the Internet 18. Ad server 32 responds by serving up the most appropriate ad to HTTP client 12 substantially at the same time the web page is presented to the client. In response to a request from the ad server 32, the publisher database 44 provides the ad server 32 with characteristics unique to the publisher 16 of the web page. The ad database 46 responds a request the ad server 32 and provides one or more ads to the ad server 32 which are appropriate for presentation with the web page of publisher 16 to the user at HTTP client 12.

In another embodiment of ad broker system 20, an advertiser 14 associated with an advertiser account on account server 30 is able to generate its own advertisement remotely on ad generation server 34. Ad generation server 34 is configured to receive ad generating data from advertiser 14 over the Internet 18 and further configured to create advertisements for presentation over the Internet 18. Advertiser 14 creates an ad on ad generation server 34 by receiving advertising generation characteristics selected by the advertiser. A CGI program, for example, can associate each of the received characteristics and with HTML code, where each of the associated pieces of HTML code can be merged to create an advertisement. Once an ad has been created, ad generation server 34 provides the ad or a URL associated with the location of the ad to ad database 46. The ad generation server 34 also provides the account server 30 with associated transactional information, such as the type of ad created (i.e., ad banner). The created ad is then available for presentation to client 12 if requested by the ad server 32. In another embodiment of the type of ad generated, the ad generation server 34 is configured to generate a home-ad page in a similar process as the creation of an ad banner. A “home-ad page,” as described herein, is a web page including product and service information (i.e., “content”) unique to the advertiser. The ad generation server 34 is configured also to provide the home-ad page to a home-ad repository (not shown) for storage once the home-ad has been created. A home-ad repository is, for example, a web server configured to provide web hosting services, as known in the art of hosting a large number of web pages.

Exemplary ad server 32 of ad broker system 20 is a computer system, which is similar in structure to account server 30, and may include a central processing unit (CPU) configured to execute computer programs (including an application and operating system software) stored in a program memory (not shown) by reading program instructions from the program memory via a processor bus. The CPU uses program memory, such as RAM (random access memory), for storage of program variables and for computational processes performed under control of application software.

FIG. 2 shows a computing device 200 suitable for use in one or more embodiments of the ad server 432 of the ad broker system as well as performing its function of presenting brokered ads to a user, according to the present invention. Computer device 200 includes display 202 having display screen 204. Cabinet 206 houses standard computer components (not shown) such as a disk drive, CD-ROM drive, display adapter, network card, random access memory (RAM), central processing unit (CPU), and other components, subsystems and devices. User input devices such as a mouse 208 having buttons 210, and a keyboard 212 are shown. User input devices, however, may also include voice command activated input devices as well as touch pads and the like. Other user input devices such as a trackball, touch-screen, digitizing tablet, etc. can be used. In general, the computer device 200 is illustrative of one type of computer system, such as a desktop computer, suitable for use with the present invention. Computers can be configured with many different hardware components and can be made in many dimensions and styles (e.g., laptop, palmtop, server, workstation, mainframe). Thus, any hardware platform suitable for performing the processing described herein is suitable for use with the present invention.

FIG. 3 illustrates subsystems that might typically be found in a computer device such as computer device 300. Subsystems within box 206 are directly interfaced to an internal bus 310. Such subsystems typically are contained within the computer system, such as within the cabinet 206 of FIG. 2. The subsystems include an input/output (I/O) controller 312, system memory, such as Random Access Memory (RAM) 314, Central Processing Unit (CPU) 316, display adapter 318, communications port 302, such as a serial port, Fixed Disk 322 and network interface adapter 324 with network I/O 326. The use of the bus 310 allows each of the subsystems to exchange data with other subsystems and, most importantly, with the CPU 316. External devices can communicate with the CPU or other subsystems via the bus 310 or by interfacing with a subsystem connected to the bus. The network interface adapter 324 of ad server 20 of FIG. 1 includes communication ports which are configured to access and communicate data to and from the other elements of ad broker system 20, such as the transactional database 42, the publisher database 44 and the ad database 46.

Monitor 204 connects to the bus through display adapter 318. A relative pointing device (RPD) such as a mouse 208 connects through serial port 302. Some devices such as keyboard 212 can communicate with the CPU 316 by direct means without using the main data bus as, for example, via an interrupt controller and associated registers (not shown).

As with the external physical configuration shown in FIG. 2, many subsystem configurations are possible. FIG. 3 is illustrative of one suitable configuration. Subsystems, components or devices other than those shown in FIG. 3 can be added. A suitable computer system can be achieved without using all of the subsystems shown in FIG. 3. Other subsystems such as a CD-ROM drive, graphics accelerator, etc. can be included in the configuration without affecting the performance of the system of the present invention.

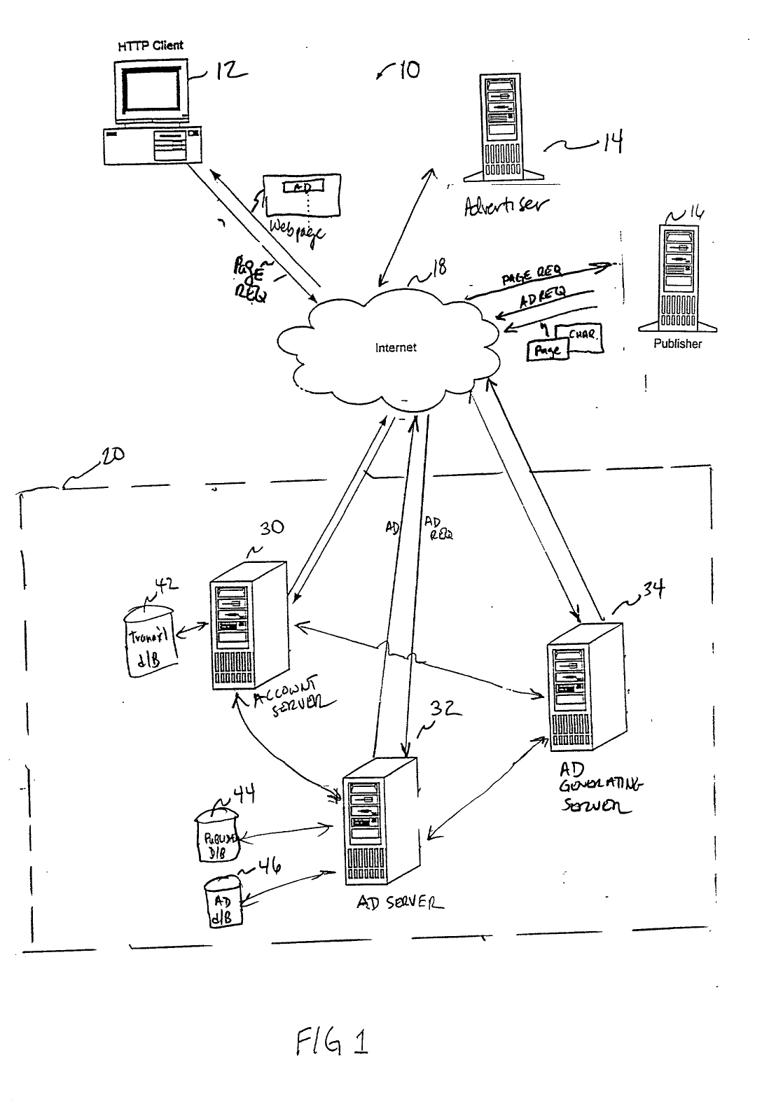

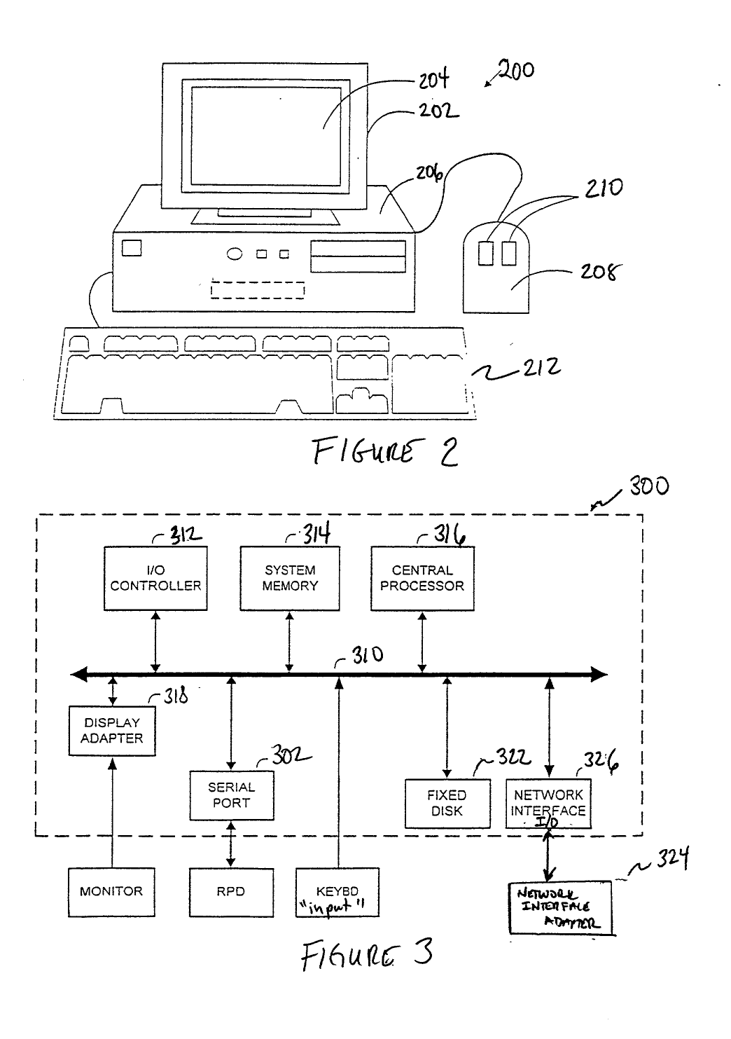

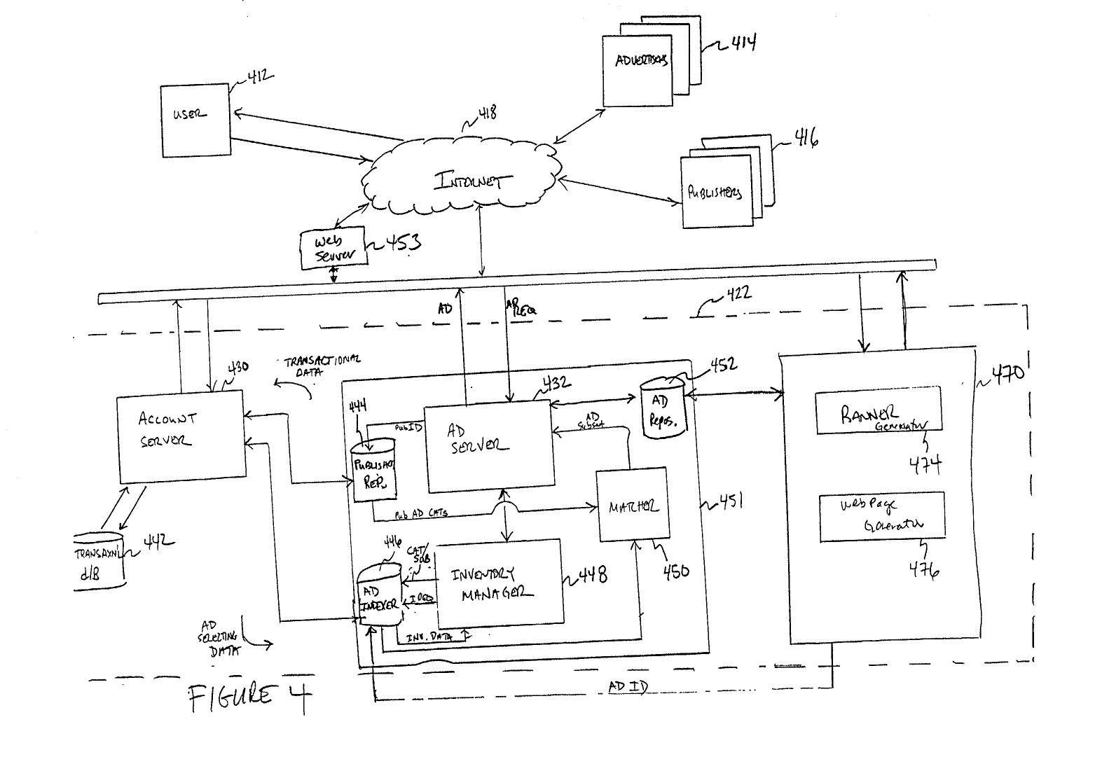

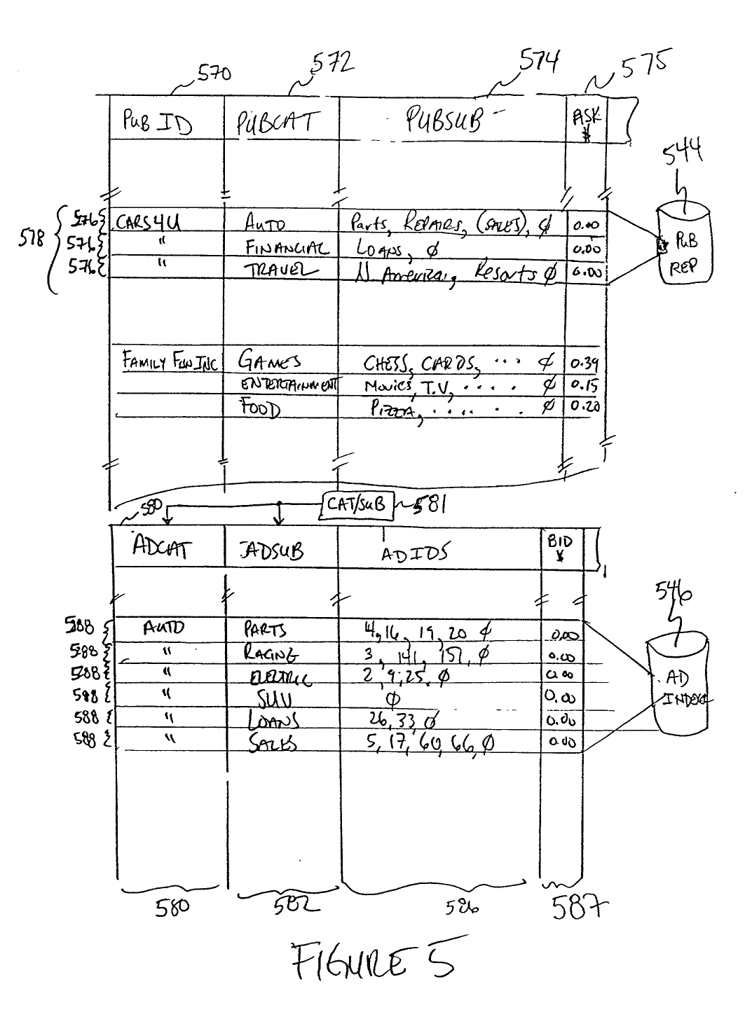

FIG. 4 illustrates a more detailed depiction of an exemplary ad broker system of FIG. 1. In a specific embodiment of the present invention, ad broker system 422 comprises an account server 430 and an ad servicing engine 451, where the ad servicing engine includes one or more of the following: an ad server 432, an inventory manager 448, a publisher repository 444, such as publisher database, an ad repository 452, an ad indexer 446, and a matcher 450. In one embodiment, the ad server 432 is an Internet node and is configured to exchange information with a communications network, such as the Internet. More specifically, ad server 432 is configured to receive a URL and is further configured to return a Hypertext Markup Language (HTML) ad for the browser to display. The browser is one example of an HTTP client and is so named because it displays both a returned hypertext document (i.e., web page) from a publisher and an ad selected for presentation by ad server 432.

In one embodiment of the inventory manager 448 and matcher structure 450, both are structurally and operationally similar to computing device 200 in FIG. 2. In another embodiment the inventory manager 448 and matcher structure 450 and operationally disposed within ad server 432 without affecting each element's respective function. Matcher 450 is configured to provide a sub-set of available ads to ad server 432 and will be discussed in more detail below. Inventory manager 448 operates to manage and organize the inventory of available ads such that the number of ads available for presentation are adequate to meet the requests for ads from individual publishers. Inventory manager 448 is coupled to ad server 432 to receive, for example, a request to present ads related to a specific category or subcategory and is further coupled to ad publisher repository 444 and ad indexer 446.

Ad indexer 446 is coupled to inventory manager 448 to receive signals IREQ and CAT/SUB, and to provide INVDATA. Signal IREQ is generated by inventory manager 448 to request inventory be taken of all ads available for presentation according to each particular ad category and ad sub-category. Ad indexer 446 responds by providing the inventory data, INVDATA, to the inventory manager for evaluation. In one embodiment of the inventory manager 448 determines whether each subcategory of ads has a sufficient number of ads available for presentation. For example, if each subcategory has a corresponding number of ads available that exceed a minimum number (SUBmin), then signal CAT/SUB will be assigned a value (e.g., HI, etc) that permits each individual subcategory of ad to be provided to matcher 450, which will be discussed in more detail below. If a subcategory, however, fails to exceed SUBmin, then signal CAT/SUB will be assigned a value (e.g., LO, etc) which causes a corresponding category, rather than subcategory, of ad to be provided to matcher 450. In another embodiment of the inventory manager 448, an broker administrator establishes SUBmin. However, it is also within the scope of the present invention to set SUBmin automatically, as determined in accordance to criteria provided to the inventory manager 448 by the an ad broker administrator.

According to a specific embodiment of the present invention, the publisher repository 444 and ad repository 452 are included in computing devices, such as servers, that are configured as databases to store and allow speedy access to a large amount of data to practice the present invention. Publisher repository 444 is coupled to ad server 432 to receive, for example, a publisher ID “PUBID” where each publisher is associated with a unique PUBID. As part of an ad request, the PUBIDs are provided by ad server 432 to publisher repository 444 for determining which categories and subcategories of ads are most suitable to present to a particular publisher's target audience. Ad repository 452 is coupled to provide ad server 432 a selected ad (or equivalent UTRL) based upon the output of Matcher 450. In another embodiment of the present invention, the publisher repository 444 and ad repository 452 are respectively configured to communicate at least one publisher characteristic and at least one advertisement (i.e., advertisement presentation and transactional data) from the account server 30 of FIG. 1.

Publisher repository 444, ad indexer 446 and ad repository 452 include a collection of information where the information is organized such that data can be quickly a accessed and retrieved. Each repository is organized by fields, records, and files. A field is a single piece of information; a record is one complete set of fields; and a file is a collection of records. For example, a telephone book is analogous to a file. It contains a list of records, each of which consists of three fields: name, address, and telephone number. Alternatively, each repository is configured to include a hypertext database, which is well known in the art of database management systems. Such repositories include any object (i.e., a piece of text, a picture, audio or video) that is linked to any other object. The exemplary repositories include hypertext databases, which are particularly useful for organizing large amounts of disparate information.

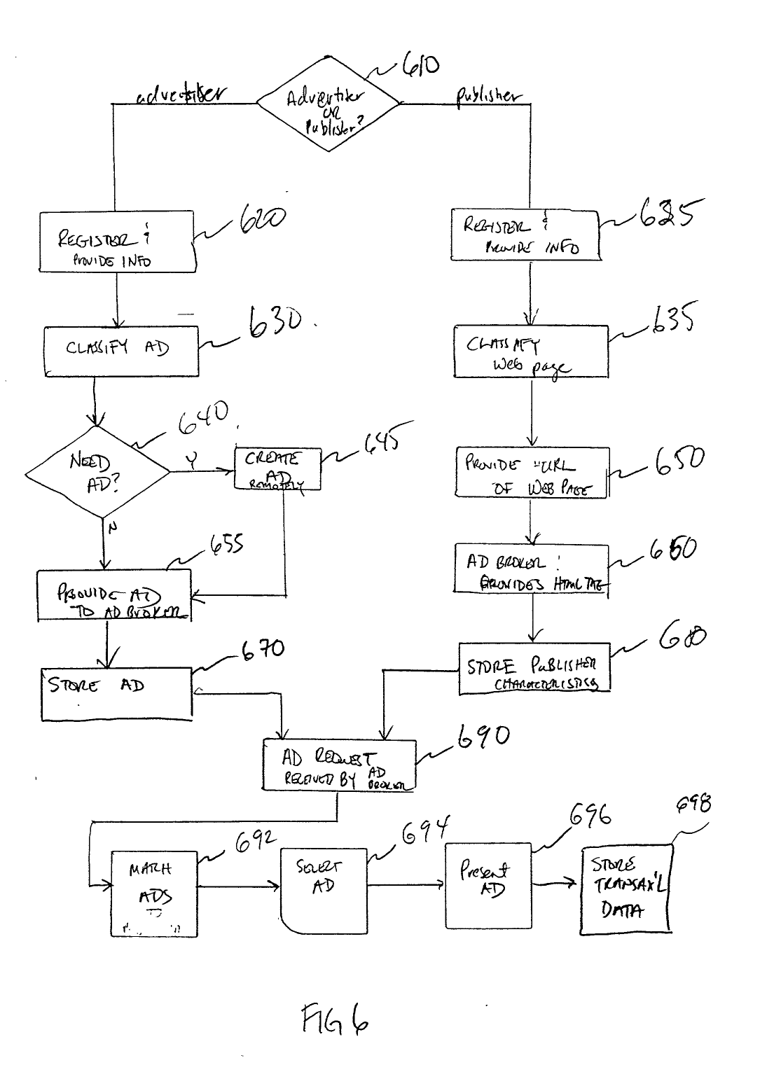

More specifically, repositories 444, 446 and 452 store data in exemplary data structures shown in FIG. 5. In one embodiment of the present invention, publisher repository 544 includes a large number of records 576 in a table data structure associated with a number of publisher files 578 that are associated with a specific publisher. More specifically, each record 576 has one or more fields to include at least a PUBID 570 and an ad subcategory type 574 (“PUBSUB”). In another embodiment, record 576 also includes an ad category type 572 (“PUBCAT”). The PUBID 570 is, for example, a text label representing an IP address or URL associated with a publisher's web page for ad presentation, or any other identification means. A PUBID may be the name of the publisher's company and may be entered by the publisher, or automatically assigned by the ad broker system 422 of FIG. 4.

Fields 572 and 574 are populated with information provided by account server 430 from FIG. 4 and store data representing ad categories and subcategories which permits or denies certain ads from being presented on a publisher's web page. Permissible ad cat/subcategories are selected, for example, by the publisher to best present product and service information to its web page viewers. Alternatively, denied ad cat/subcategories are, for example, selected by the publisher to prohibit certain ads from being presented on the publisher's web page, such as a competitor's advertisement or otherwise unsuitable content given the target audience. In another embodiment, a publisher also includes for each ad subcategory, a field 575 for the lowest cost for an ad presentation that the publisher will accept. This is the “ask price.”

In the example shown in FIG. 5, a car dealer involved in new and used car sales, named “Cars4U” has selected ad categories, “auto,” “financial,” and “travel” as permissible categories in which ads are to be selected. In an each respective ad category, the Cars4U publisher has selected subcategories “parts,” “repair” and “(sales)” under category “auto;” subcategories “loans” under category “finance;” and “North America” and “resorts.” The null (i.e., “0”) simply represents the end of the subcategory list and is a well-known computing technique for marking the end of the list. In this example, a parenthetical selection such as “sales” indicates that Cars4U denies presentation of ads involving “sales” of cars. Naturally, a publisher such as Cars4U would not to present its sales competitor's ads on its web page.

Also in the example illustrated in FIG. 5, ad indexer 546 includes a large 25 number of records 588 in a tabular data structure having at least an ad category 580 (“ADCAT”), a subcategory 582 (“ADSUB”) and ad ID 586 fields. The ADCAT 570 is, for example, a highest level match tag having a text label representing a collection of similar ads. The ADSUB is a lower level match tag having a text label representing a subset of ads within the ad category 580 in which it resides. Each Ad ID 586 in record 588 is an numeric value representing a single ad stored in ad database 552 and the one or more the Ad IDs in a record 588 are classified logically under the associate ADSUB 582. For example, ADCAT 580 includes high-level descriptions “Auto,” “Entertainment,” etc. in which to further classify ads into ADSUBs 582. ADCAT “Auto” includes subsets of ads sub-classified logically into such subcategories as “Parts,” “Racing,” “Electric,” “SUV,” “Loans,” “Sales,” etc. Each ADSUB 582 is related an associated list of ad IDs 586. For example, ad IDs 4, 16, 19, and 20 are associated with the “Parts” ADSUB as well as to the higher-level classification “Auto.” Although the preceding example shows only two levels of classification (i.e., ADCAT and ADSUB), it should be appreciated by those skilled in the field of hierarchical database management that more levels are subdivision are possible and thus are within the scope of the present invention. Additionally, according to another embodiment of the present invention, each of the ads is arranged in a “parent-child” hierarchy as is known in the art. In another embodiment, an advertiser also includes for each ad subcategory, a field 587 for the highest cost for an ad presentation that the advertiser will pay. This is the “bid price.”

Exemplary ad indexer 546, in one embodiment, is configured to receive CAT/SUB signal 581 (e.g., CAT enable and SUB enable signals) from the inventory manager 448 of FIG. 4. These signals are applied to the ad indexer 546 when a list of ad IDs are required to be accessed, such as when an ad request has been received by the inventory manager, and are used to received an appropriate ad ID list or lists. The inventory manager determines whether there are one or more subcategories failing to meet the minimum threshold, SUBmin. In the example of FIG. 5, since the ADSUB 582 “SUV” has no ad IDs 586 (i.e., no ads available for presentation), the inventory manager will then enable all records 588 associated with ADCAT 580 “Auto” to be available for presentation by applying CAT enable to the ad indexer 546. Alternatively, the inventory manager may determine that ADSUB 582 “Parts” have an appropriate number of ad IDS 586 over the SUBmin threshold, then an applied SUB enable signal will then only make available those ad IDS 586 associated with the record 588 having SUBCAT 582 “Parts.”

It should be understood that the data structures of publisher repository 444, ad indexer 446 and ad repository 452, as shown in FIGS. 4 and 5, represent one of many possible data arrangements. Only a few records 576 and 588 are shown, but in practice, many millions of records might be present. Furthermore, each of the records in the data structures of the publisher repository 544 and ad repository 452 as well as the data stored within the fields, for example, are associated with a physical disk location of a disk drive in which ad server 432 may access the data. It should be understood that there is a variety of physical embodiments where records 576 and 588 reside and a skilled artisan recognizes such media for storing and accessing the records.

In reference to FIGS. 4 and 5, matcher 450 is coupled to the Publisher repository 444 to receive, for example, the records 576 associated with the PUBSUB 574 for a specific PUBID 570. Matcher 450 is coupled further to ad indexer 446 to receive either a record 588 associated with an ADSUB 582 or all the records 588 of a particular ADCAT 580. Match 450 operates to compare the PUBSUB 574 list or lists of records 576 to the ADSUB 582 of records 588 for providing a subset of ad IDs 586 to the ad server 432. For example, for PUBID 570 “Cars4U,” all the PUBSUB 574 lists will be provided to matcher 450 when requested to do so by the ad server 432. That includes the records 576 containing “parts,” “repair,” “(sales),” “loans,” “finance,” “North America” and “resorts.” Inventory manager 448, upon receiving an ad request from ad server 432, will apply either CAT signal or SUB signal to ad indexer 446. Regardless, whether the inventory of the ad indexer 446 has been determined contemporaneously or previously, the inventory manager 448 applies the SUB signal to select those ADSUBs 582 that have a number of ad IDs 586 meeting SUBmin (e.g., a threshold of one or more ads related to a specific ADSUB 582). After receiving the SUB signal, ad indexer 446 provides those records 588 associated with ADSUBs “Parts,” “Racing,” “Electric,” “Loans,” and “Sales.” Note “SW” was not provided since it failed to meet SUBmin of at least 1 ad.

The matcher 450, operating under a sorting algorithm, operates to first match “Parts” with “Parts,” “Loans” with “Loans” and “Sales” with “(Sales),” wherein no matching results with PUBSUBs “repair,” “North America” and “resorts” or with ADSUBS “Racing” and “Electric.” Matcher 450 will disregard ad IDs 586 associated with “Sales” since the publisher denied the PUBSUB “(Sales)” to be presented on its web page. Then, matcher 450 operates to provide the subset of ad IDS 586 to ad server 432. Ad Server 432 then determines, for example, under control of software, the most appropriate ad to be presented to the user. In another embodiment, matcher 450 functions to match further those ads that have an bid price equal or greater than a publisher's asking price. Hence, the matcher provides a subset of ads that are brokered between advertisers and publishers.

According to the present invention, ad server 432 evaluates each one of the ads associated with the ad IDs against a set of predetermined criteria to determine which is the most suitable for presentation. “Suitability” and “appropriateness” is determined by criteria set my the ad broker administrator such as the amount of the transactional rate (i.e., percentage ), the number of impressions remaining for a particular ad, the time frame of guaranteed number of impressions, etc. The transactional rates, or fee for using the ad broker may be different for various advertisers and the ad server 432 may seek to first present ads that are more lucrative than other ads.

In yet another embodiment, as shown in FIG. 4, the ad broker system 422 includes an ad generator 470 for generating advertisements remotely within the ad broker system such that an advertiser uses a client computing device coupled to the Internet, for example, to create advertisements for presentation on web pages. Remote ad generation allows an advertiser to create its own ad banners or home-ad pages without having to understand HTML or investing in web publishing resources and software programs to locally create their own advertisements. An ad generated with the ad generation server 470 is available substantially after the advertiser finishes creating the advertisement (e.g., confirms purchase of ad).

Ad generation server 470 is configured to exchange information over a communications network with an advertiser at a client-advertiser 414 computing device. The exchanged information, for example, includes communicating requests for HTML documents from the advertiser to the ad broker system, where the information is used to generate an advertisement. Ad generation server 470 is coupled to the account server 430 for storing an ad ID associated with remotely created ad in the ad indexer. Ad generation server 470 is also coupled to ad repository 452 for storing the ad or the location of the ad. As discussed above, and ad stored in the ad repository also includes a URL wherein the ad may be stored external to the ad broker system and retrieved therefrom, if request. For example, although an ad may be generated by the ad broker system, it may be stored on a third party server machine (i.e., web hosting platform).

In one embodiment, ad generation server 470 is structurally and functionally equivalent to computer device 100 although it need not include a monitor, mouse or keyboard. Ad generation server 470, under the control of software, is adapted to parse and collate the incoming requests by the client-advertiser into a single file. The file comprises program instructions (e.g., HTML script) for execution either as an ad banner or as a home-ad page regardless of where the file resides. Ad generation server 470 then may include banner generator 474 and web page generator 476 where Internet ad banner files and home-page files are respectively created. Such files are computer programs and reside, for example on a computer-readable medium accessible to the ad server 432 for presentation to the user.

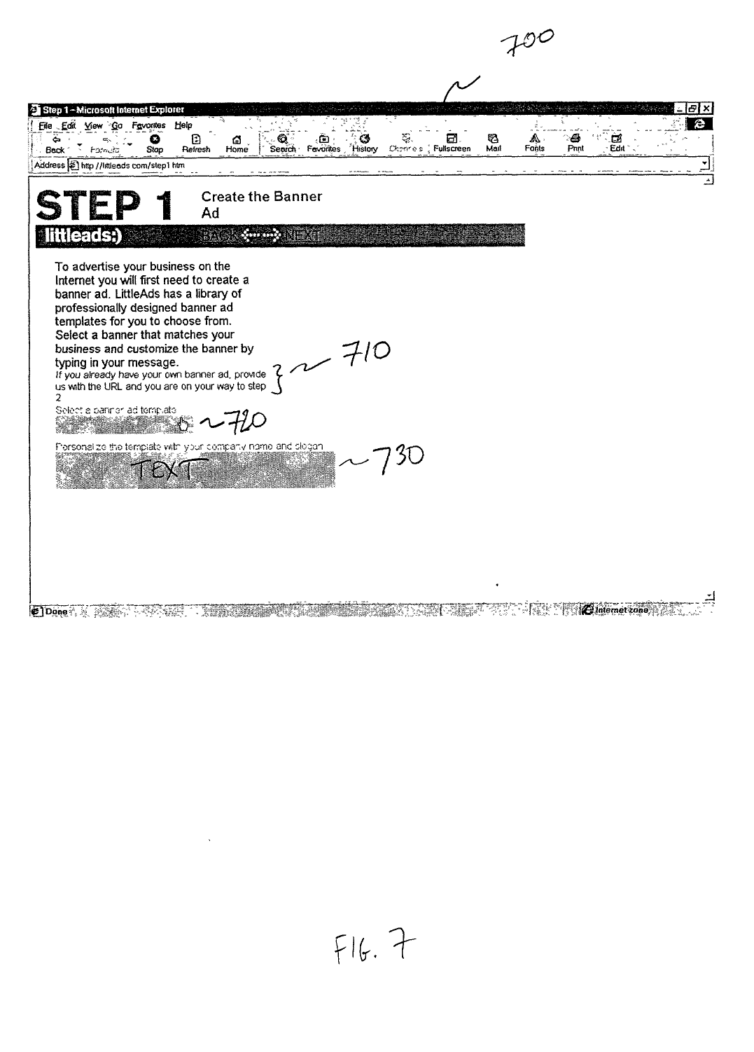

FIG. 6 illustrates an embodiment of the method of the present invention. At 610, a potential advertiser or publisher registers with the ad broker system and provides transactional data, as described above, at 620 and 625. At 630 and 635, an advertiser and publisher, respectively, includes the ad categories and ad subcategories that are best related to their needs, such as the content of the ad or the publisher's page audience. At 640, the advertiser may decide to create its own at 645 remotely as described herein, or may provide an ad to the ad broker system at 655. At 650, a publisher may provide a URL of the web page in which ad space is being offered. The ad broker system then may automatically retrieve the HTML source code from the web page, insert the ad broker's HTML tag for directing an ad request from the publisher's page to the ad broker. The modified HTML is then provided to the publisher at 660 to allow brokered ads to be presented on the publisher's web page. A skilled artisan should understand how employ HTML tags such as described. At 670 and 680, ads and publisher characteristics are stored as described above.

At 690, when the ad broker receives an ad request, the ad broker system operates to match ads at 692 to determine which ad should be presented. Matching is performed by comparing a publisher's permissible ad subcategories against an advertiser's elected ad categories or subcategories. A subset of similar subcategories are generated. Then publisher denied ad subcategories are removed from consideration. In another embodiment, the publisher's minimum asking price is compared to the advertiser's maximum bid price and further selects ads where the publisher's minimum asking price is below the advertiser's maximum bid price.

At 694, the most suitable ad is selected according to criteria set by an ad broker administrator. At 696, the selected ad is presented to the web user who initiated the ad request. Accordingly, at 698, the transaction is archived, for example, by providing transaction data to an account server. A publisher's account will be credited with the ad presentation, the advertiser's account associated with the ad will be debited, the number of impressions remaining will be decremented such that if an advertiser selects an ad campaign of 500 ads, after a corresponding ad's first presentation the number of impressions remaining will be 499.

If an advertiser has already registered to participate in ad brokering, the advertiser may generate its own ad banner remotely. Ad generation server 470, as shown in FIG. 4, provides a number of advertisement generation selections (e.g., inputs) on web page 700 that is available to a client-advertiser as shown in FIG. 7. If the advertiser created an ad external to the ad brokering system, the advertiser may provide the created ad by selecting 710. If selected, the advertiser may either provide the ad by downloading the file to the ad broker system 422, or alternatively, by supplying a link (e.g., a URL) in which the externally created ad may be accessed for presentation to the user.

If an advertiser wishes to create its own advertisement, it need only a computing system operating with a browser to access the Internet. At 720, the advertiser is presented with at least one selection, such as one or more ad banner templates. In one embodiment, the ad banner templates refresh periodically with a new banner template until a user selects a particular banner. The ad banner template is a graphical object linked by hypertext link associated with an HTML tag. When the advertiser selects a particular template, the HTML tag associated with that ad banner will be saved in a file located remotely in the ad generation server 470. At 730, the advertiser may choose a selection to enter a text message to be displayed in the foreground of the ad template. Such text messages may be of varying font, characters, etc., which are well-known in the art. As described herein, an advertisement generation characteristic is data representing a portion (whether visual, audio, or other) of the advertisement which is influenced by the characteristic. Such characteristics include the size, shape, color, graphic, etc., available to the advertiser for selection.

In FIG. 8, an advertiser may be presented a variety of selections on web page 800 associated for remotely generating a home-ad page, which is essentially a simple web page. Similar to the creation of the ad banner, the advertiser is presented with selection 810 to provide an externally created home-ad page. At 830, one or more pre-existing web page templates are presented to the user selection. Each web page allows the non-technical advertiser with the ability to create an brochure-style web page, or home-ad, which is hosted by an ad brokering system, or by an third party host. At 820, the advertiser may select a variety of colors to modify different attributes of its selected home-ad page. Although more characteristics are available to modify, such as size of ad banners, selection of audio to accompany an ad, etc., are within the scope of the present invention, a skilled artisan should understand how to enhance the characteristics of the advertisements without undue effort, upon reviewing the present invention as disclosed herein.

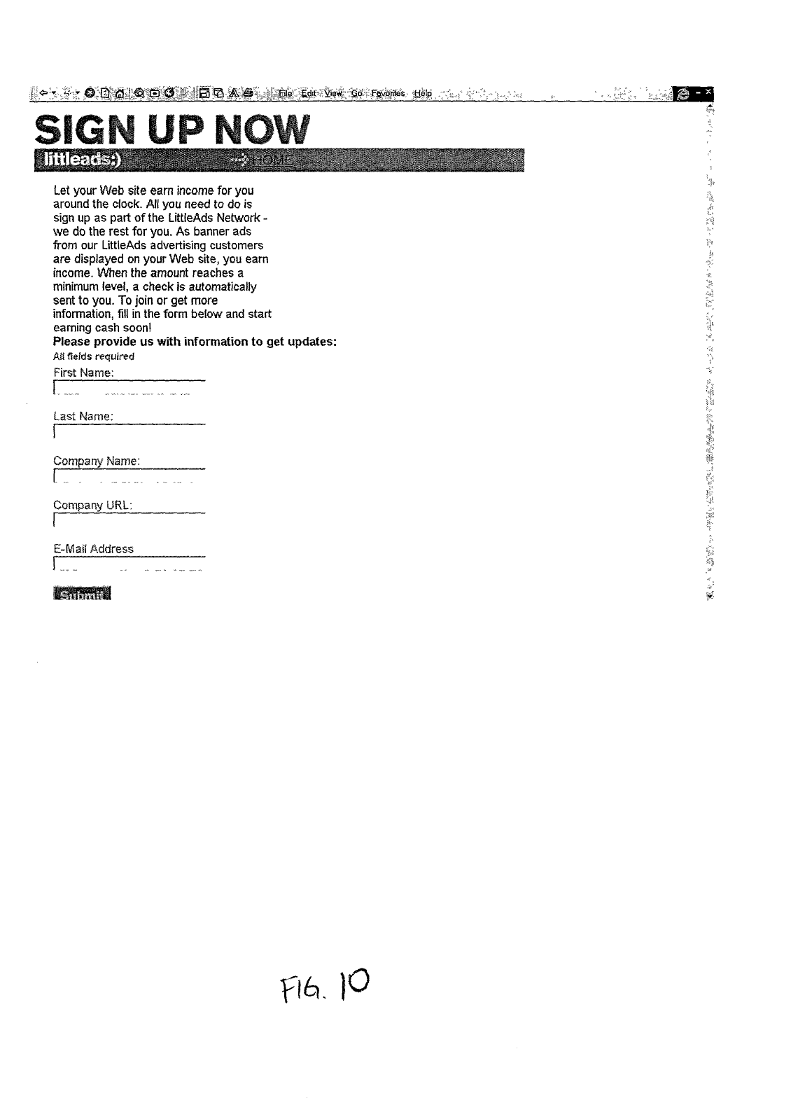

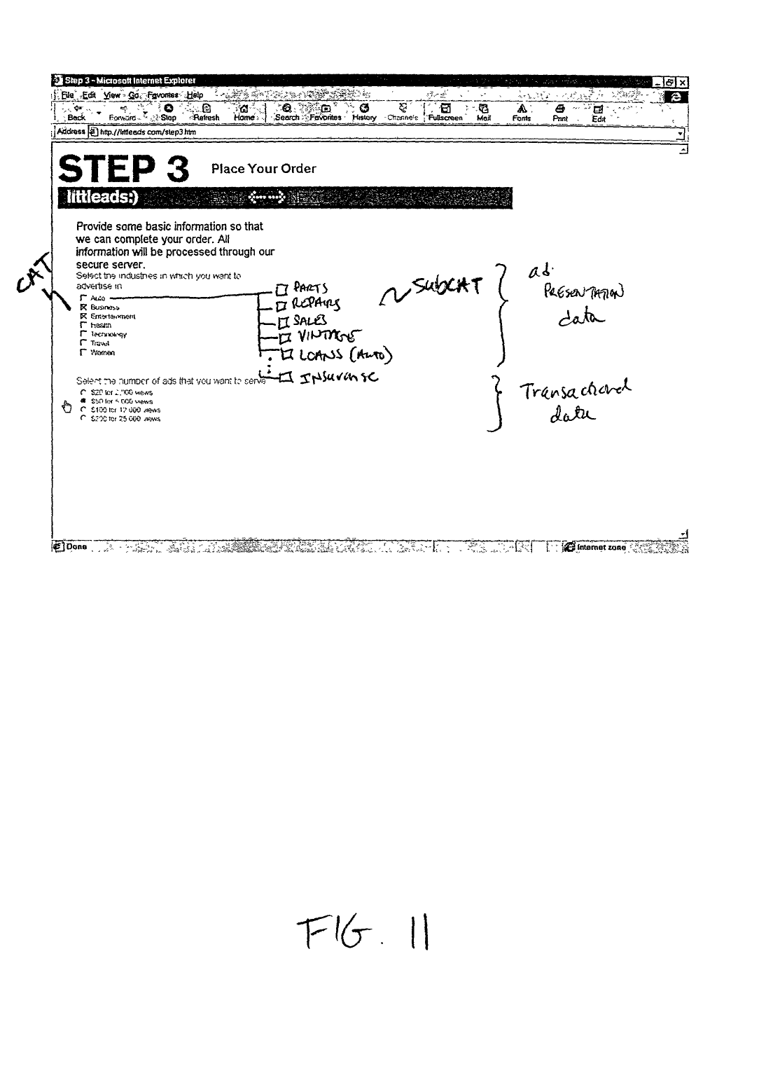

Ad generation server 470 operates to remotely create advertisements as described herein according to an exemplary process shown in FIG. 9. The ad generation server resides in a distributed communications network, such as coupled to the Internet, and communicates with an advertiser at an advertiser's computing device (i.e., client-advertiser). At 910, the advertiser is presented selections in which it is to choose to create a unique advertisement remotely at the ad generation server, similar to 710 and 810 of FIGS. 7 and 8 respectively. The advertiser selects certain “ad generation characteristics” to change the appearance or the presentation of the advertisement. As described herein, “ad generation characteristics” refer to varying ways an internet ad may be modified, as known in the art, such as adding color, text, etc.,

At 920, the advertiser accepts a selection for influencing the creation of the advertisement. More specifically, a selection may be accepted by, for example, clicking on a hypertext link. An exemplary hypertext link is used to determine what ad generation characteristic has been selected. At 930, the ad is generated remotely at the ad generation server 470 where for example, the ad is generated by modifying pre-existing templates. A pre-existing template includes pre-defined graphics and GIF animation, where GIF (i.e., graphics interchange format) is a bit-mapped graphics file format used by the World Wide Web. A pre-existing template provides a backdrop for presenting text and may include graphics such as swaying palm trees, geometric shapes, kittens, or any other graphic. It is also within in the scope of the present invention to provide other types of presentation media, such as audio and odoriferous advertisements.

At 940, an ad banner is generated by modifying a pre-existing ad template, such as changing a background having “bricks” to “plaid,” or alternatively, by font type from “New Times Roman” to “Courier.” At 950, an home-ad page (i.e., ad brochure web page) is generated by modifying a pre-existing ad template, such as changing a background having “red bricks” to “green and white plaid.” The advertiser's ad and the generation thereof, continues by continually performing steps 910 to 950 by adding, replacing or deleting ad generation characteristic criteria.

Ad generation occurs when an advertiser first registers to generate a remotely created ad, or alternatively, occurs at some period of time thereafter in which the advertiser might wish to change the presentation of the ad. The advertiser continues generating his or her ad until at 960, the advertiser confirms its selections and finishes by selecting the pre-existing ad templates. In one embodiment, the ad characteristics are merged or appended to a file, such as a computer program. When called, the file presents the ad to a customer along with a publisher page. Such an ad file may be stored within ad generation server 470, in an ad brokering system, or a third party web host.

In a specific embodiment where the ad generation server is used in conjunction with an ad brokering system, an ad ID is generated at 975 to associate the advertisement to a particular ad category or sub-category to optimize presentation to a targeted audience. The exemplary ad ID is stored in an ad indexer for selection as an ad based upon the content of the publisher web page. Furthermore, such generated ad is stored at 977 in the ad repository of 452 of FIG. 4 for later presentation.

The ad is then presented at 980 to a potential customer (i.e., user) using the Internet to browse possible goods and services for purchase. The ad generally accompanies the display of a publisher's web page, where the ad is presented the consumer by way of a display on the user's computing device (i.e., client-user).

It should be understood that the remote generation of an advertisement, according to the present invention, uses an applet program with an ad generation server 470. Applets are designed to be executed from within another software program, such as a browser. Unlike the browser, however, applets are not executed directly from the operating system of the user's computing device. In still another embodiment, a CGI program (Common Gateway Interface), is used to transfer information between the ad generation server 470 and the client-advertiser, where the CGI program resides and operates at the server (i.e., “server-side”) so that it interacts dynamically with the advertisers.

In summary, a novel ad broker system and method with remote ad generation has been invented and is described herein. The ad broker system approach removes the barriers for web publishers and advertisers to participate in Internet advertising and the remote ad generation ability permits non-technical advertisers to create Internet ads without substantially expending unnecessary resources.

The above description is illustrative and not restrictive. Many variations of the invention should be apparent to those of skill in the art. For example, the present invention may also broker ad provided by traditional publishers, such as web portals and search engines, rather than just those ads provided by registered advertisers. Thus, a significant amount of inventory may come from ISPs, hosting facilities and other sources that have sold more advertisements than they can serve. In addition, a participant in the ad broker system also can be both an advertiser and a publisher. Furthermore, the account server of the present invention is suited for generating and electronically distributing financial reports, as to publisher's income and advertiser campaign specifics. The scope of the invention should, therefore, be determined not with reference to the above description, but instead should be determined with reference to the appended claims along with their fall scope of equivalents.

What is claimed is:

1. A method of creating an advertisement in a distributed communications network for presentation to a client-user with a publisher web page, in which a client-advertiser communicates with an ad generation server, the method of remote advertisement generation comprising:
providing a client-advertiser with a plurality of selections, each of the selections associated with an ad characteristic, where the characteristic defines a portion of the advertisement to be generated;
accepting at least one of the selections to generate the advertisement; and
creating the advertisement remotely in the ad generation server when a final portion of the advertisement has been accepted from the client-advertiser, where the final portion is associated with a final selection.

2. The method of claim 1, wherein providing an client-advertiser with a plurality of selections includes providing a plurality of pre-defined ad templates to display for selection.

3. The method of claim 1, wherein creating the ad remotely comprises:
modifying the advertisement based upon the ad characteristic defined by a link; and
appending each ad characteristic to a file;
wherein the file includes program instructions to dynamically present the advertisement to the user.

4. The method of claim 1, wherein the advertisement is an ad banner.

5. The method of claim 1, wherein the advertisement is an web page.

6. The method of claim 1, wherein accepting at least one of the selections comprises:
presenting to the client-advertiser a plurality of advertisement generation inputs to select;
selecting at least one of the advertisement generation inputs;
associating an ad generation characteristic with the selected advertisement generation input, wherein the advertisement generation characteristic is data used to create the advertisement.

7. The method of claim 1, wherein accepting at least one of the selection further comprises associating a link to define the ad characteristic, where the link is a Uniform Resource Locator (URL).

8. The method of claim 7, wherein the link defines an HTML tag for defining the ad characteristic.

9. An automated ad broker system for selecting an brokered advertisement from a plurality of advertisements and presenting to a user the brokered advertisement via a communication network, the system comprising:
an account server coupled to the communication network to receive ad presentation data from publishers and advertisers; and
an ad serving engine coupled to the account server to receive the ad presentation data, the ad serving engine further coupled to the communication network to provide a selected ad to the user,
wherein the brokered advertisement selected for presentation is a remotely generated ad.

10. The system of claim 9, wherein the remotely generated ad is created by an ad generation server.

11. The system of claim 9, wherein the ad servicing engine further comprises:
an ad server coupled to the communication network to provide the brokered advertisement to the user;
an ad repository to store a plurality of advertisements;
an inventory manager configured to receive an ad request from the ad server, where the inventory manger is coupled to the ad repository to manage the level of categorization of the each of the plurality of advertisements;
a publisher repository configured to receive a publisher ID from the ad server, the publisher repository including a plurality of publisher ad categories;
a matcher coupled between the publisher repository and the ad repository to match a subset of ads for presentation, where the matcher is configured to provide the ad server the subset of brokered ads; and
an ad generation server configured to provide the remotely generated ad to the ad repository,
wherein the ad server determines which one ad of the subset of brokered ads is to be presented, the subset including the remotely generated ad.

12. A method of brokering an advertisement for presentation to a user the advertisement accompanying a publisher web page associated with a publisher ID, wherein the user, an advertiser and a publisher communicate in a distributed computer network, the method comprising:
receiving at least one permissible publisher ad category associated with the publisher ID;
matching a subset of ads associated with advertiser ad categories against the at least one permissible publisher ad category; and
forming a subset of advertisements, where each advertisement of the subset has one or more matched categories;
choosing an ad from the subset of matched ads to present to the user based upon ad selection criteria,
wherein the advertisement is generated by:
providing a client-advertiser with a plurality of selections, each of the selections associated with an ad characteristic, where the characteristic defines a portion of the advertisement to be generated;
accepting at least one of the selections to generate the advertisement; and
creating the advertisement remotely in the ad generation server when a final portion of the advertisement has been accepted from the client-advertiser, where the final portion is associated with a final selection.

13. The method of claim 12, the method further comprising:
discarding denied publisher ad categories associated with the publisher ID;
receiving a publisher ask price associated with the at least one permissible publisher ad category; and
matching a subset of ads associated with an advertiser bid price against the publisher ask price, wherein the matched subset of ads include those ads having a bid price greater or equal to the publisher ask price
